(19) United States
(12) Patent Application Publication
(10) Pub. No.: US 2025/0284087 A1
(43) Pub. Date: Sep. 11, 2025

(54) ROTARY DIAL STRUCTURE

(71) Applicant: ABILITY ENTERPRISE CO., LTD., New Taipei City (TW)

(72) Inventors: Hung-Chia CHANG, New Taipei City (TW); Chih-Kang CHANG, New Taipei City (TW); Yu-Li TSAI, New Taipei City (TW)

(21) Appl. No.: 19/055,556

(22) Filed: Feb. 18, 2025

(30) Foreign Application Priority Data
Mar. 5, 2024 (TW) 113202282

(51) Int. Cl. G02B 7/02; G03B 17/12; H04N 23/54; H04N 23/667

(52) U.S. Cl. CPC G02B 7/023; G03B 17/12; H04N 23/54; H04N 23/667

(57) ABSTRACT

A rotary dial structure comprises a base, an inner ring component and an outer ring component. The inner ring component is on the base. The outer ring component sleeves onto the inner ring component, the outer ring component and the inner ring component are relatively movable between a first position and a second position, and the outer ring component and the inner ring component are synchronously rotatable at the first position or the second position. The rotary dial structure provided by the present invention is capable of switching modes by moving the outer ring component and adjusting the settings of the switched modes by rotating the outer ring component, thereby achieving a real-time and rapid adjustment.

This application claims the benefit of the Taiwan Application Serial No. 113202282 filed Mar. 5, 2024, the disclosure of which is incorporated by reference herein in its entirety.

### TECHNICAL FIELD

The present invention relates in general to a rotary dial structure, and more particularly to a rotary dial structure operable by sliding and rotating.

### BACKGROUND

Currently, electronic devices on the market can utilize different rotary dial structures or screen menus to adjust the operating modes or parameter settings of the electronic devices. When users need to adjust the modes or parameters of the electronic devices, they are required to separately operate the rotary dial structures corresponding to these modes or navigate through the screen menus to make the necessary adjustments. However, such rotary dial structures are unable to provide users with a real-time and efficient way to quickly adjust the settings for different modes of the electronic devices.

### SUMMARY

In view of the shortcomings of the existing technology, the present invention relates to a rotary dial structure that allows mode switching by moving an outer ring component and enables adjustment of the settings for the switched mode by rotating the outer ring component, thereby achieving real-time and rapid adjustments.

In order to achieve the above purpose, the present invention provides a rotary dial structure comprising a base, an inner ring component, and an outer ring component. The inner ring component is on the base. The outer ring component is sleeved onto the inner ring component. The outer ring component and the inner ring component are relatively movable between a first position and a second position. The outer ring component and the inner ring component are synchronously rotatable at the first position or the second position.

The above and other aspects of the present invention will become better understood with regard to the following detailed description of the preferred but non-limiting embodiment(s). The following description is made with reference to the accompanying drawings.

### BRIEF DESCRIPTION OF THE DRAWINGS

FIG. 1 is a three-dimensional (3D) view of a rotary dial structure according to an embodiment of the present invention.

FIG. 2 is an exploded view of the rotary dial structure of FIG. 1.

FIG. 3 is a 3D view of the outer ring component of FIG. 2.

FIG. 4 is a 3D view of the inner ring component of FIG. 2.

FIG. 5A is an assembly drawing of the outer ring component and the inner ring component of FIG. 2.

FIG. 5B is an assembly drawing of the outer ring component and the inner ring component of FIG. 2 from a top view.

FIG. 6 is a 3D view of the inner ring component of FIG. 3 from another viewpoint.

FIG. 7 is a 3D cross-sectional schematic view of the rotary dial structure of FIG. 1 along the section line 7-7′, illustrating the outer ring component at a first position.

FIG. 8 is a 3D cross-sectional schematic view of the rotary dial structure, illustrating the outer ring component at a second position.

### DETAILED DESCRIPTION

Each embodiment of the present invention will be described in detail below, and the drawings will be used as illustrations. In addition to these detailed descriptions, the present invention can also be widely implemented in other embodiments. Easy substitutions, modifications, and equivalent changes of any of the embodiments are included in the scope of the present invention, and the scope of the present invention depends on the subsequent claims. In the description of the specification, many specific details and implementation examples are provided to enable readers to have a more complete understanding of the present invention; however, these specific details and implementation examples should not be regarded as limitations of the present invention. In addition, well-known steps or components are not described in detail to avoid unnecessary limitations of the present invention.

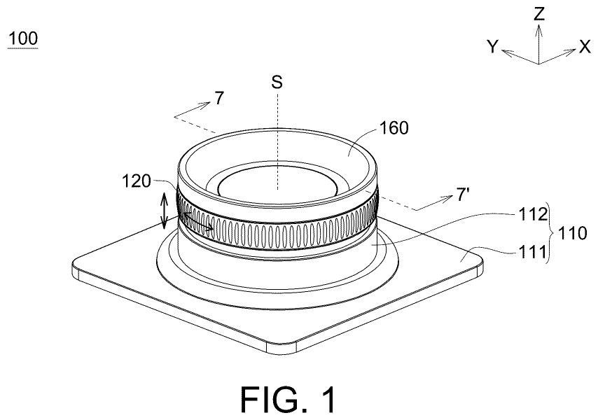

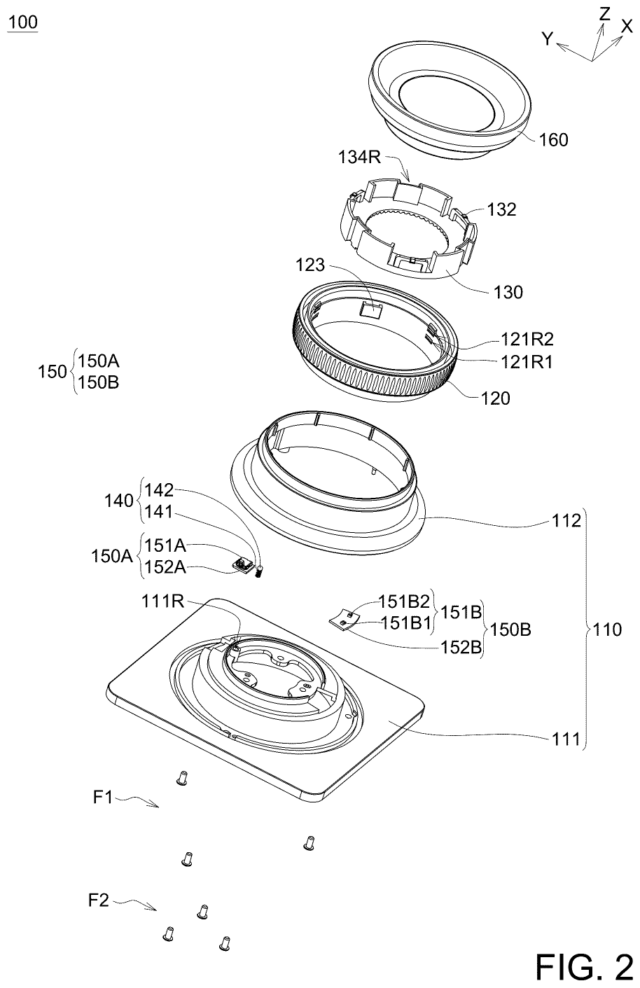

FIG. 1 is a three-dimensional (3D) view of a rotary dial structure 100 according to an embodiment of the present invention. FIG. 2 is an exploded view of the rotary dial structure 100 of FIG. 1.

Referring to FIGS. 1 and 2, the rotary dial structure 100 at least comprises a base 110, an outer ring component 120 and an inner ring component 130. The inner ring component 130 is disposed on the base 110. The outer ring component 120 is sleeved onto the inner ring component 130, so that the outer ring component 120 surrounds the inner ring component 130.

In a specific embodiment, the rotary dial structure 100 may be applied to electronic devices with light lenses, such as cameras, camcorders, projectors or sights. The base 110 may include a supporting seat 111 and a lens barrel 112, and the supporting seat 111 and the lens barrel 112 may be fixed relative to each other by a fastening element F1. The rotary dial structure 100 may further comprise a lens cover 160, and a fastening element F2 may pass through the supporting seat 111 to fix the lens cover 160 to the supporting seat 111. Additionally, a snap-fit structure or adhesive material, which is not limited by the present invention, may be used to fix the supporting seat 111 to the lens barrel 112, as well as the lens cover 160 to the supporting seat 111.

As shown in FIGS. 1 and 2, the outer ring component 120 has a rotation axis S, and the rotation axis S is parallel to the Z-axis. The outer ring component 120 may be disposed in the space between the lens barrel 112 and the lens cover 160, and the outer ring component 120 may move linearly along the direction of the rotation axis S between a first position and a second position. When the outer ring component 120 is at the first position or the second position, the outer ring component 120 rotates synchronously with the inner ring component 130 around the rotation axis S.

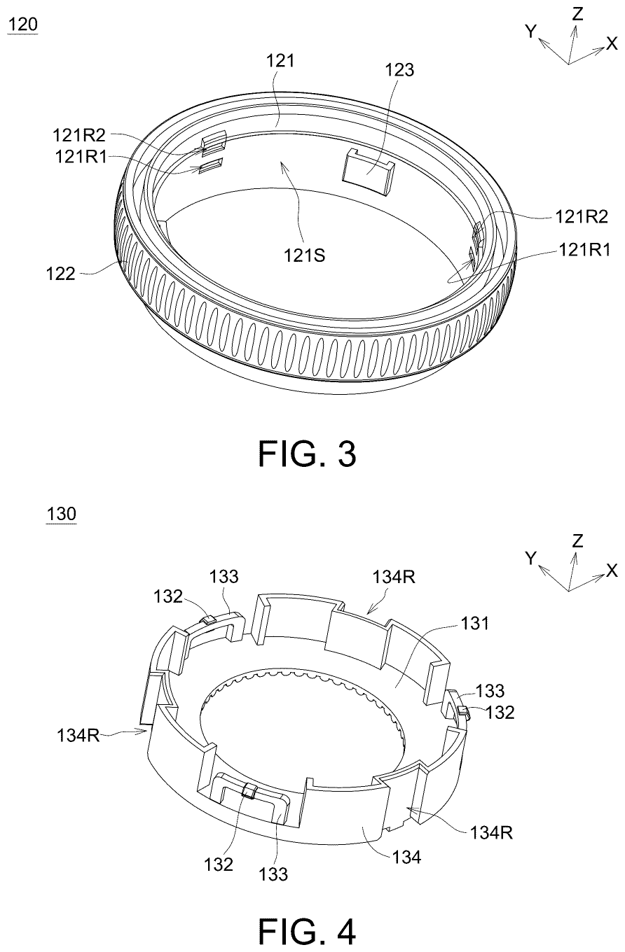

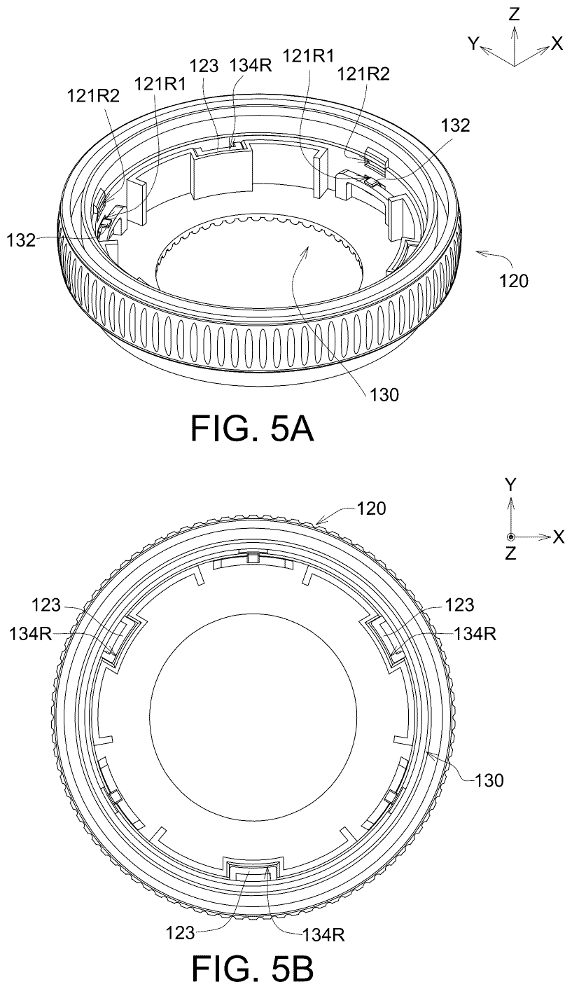

FIG. 3 is a 3D view of the outer ring component 120 of FIG. 2. FIG. 4 is a 3D view of the inner ring component 130 of FIG. 2. FIG. 5A is an assembly drawing of the outer ring component 120 and the inner ring component 130 of FIG. 2. FIG. 5B is an assembly drawing of the outer ring component 120 and the inner ring component 130 of FIG. 2 from a top view.

Please refer to FIG. 3, the outer ring component 120 may include an annular body 121, an operating part 122 and at least two first positioning parts 121R1 and 121R2. The operating part 122 is formed on the outer circumferential surface of the annular body 121 and may be used by a user to slide or rotate the outer ring component 120. The first positioning parts 121 R1 and 121R2 are on the inner circumferential surface 121S of the annular body 121 and are along the Z-axis direction. The first positioning parts 121 R1 and 121 R2 may be recessed structures.

Please refer to FIG. 4, the inner ring component 130 may include a base part 131, a second positioning part 132, an elastic part 133 and a sidewall part 134. The elastic part 133 and the sidewall part 134 are formed on the base part 131 and are located at the periphery of the base part 131. The second positioning part 132 is on one side of the elastic part 133 along the Z-axis direction relative to the base part 131. The second positioning part 132 may be a protruding structure. While the elastic part 133 is subjected to a radial pushing force or a radial pressing force, it drives the second positioning part 132 to move in response to the applied force.

In a specific embodiment, the shape of the elastic part 133 may be an inverted U-shape, but the present invention is not limited thereto. For example, the elastic part 133 may also be a straight-line shape. Alternatively, in other embodiments, the elastic part 133 may be omitted, and the second positioning part 132 may be formed on the sidewall part 134 and inherently possess a certain degree of elasticity to move in response to a radial pushing force or a pressing force.

Please refer to FIGS. 3, 4, and 5A, while the outer ring component 120 and the inner ring component 130 are assembled relative to each other, the second positioning part 132 engages with one of the first positioning parts 121 R1 and 121 R2. Taking FIG. 5A as an example, the second positioning part 132 is engaged with the first positioning part 121 R1, at which point the outer ring component 120 is at the first position. While the outer ring component 120 slides in the negative Z-axis direction, the second positioning part 132 moves and engages with the first positioning part 121 R2 due to the elasticity of the elastic part 133, at which point the outer ring component 120 is at the second position. Therefore, the outer ring component 120 is at the first position or the second position by engaging the second positioning part 132 with one of the at least two first positioning parts 121 R1 or 121 R2.

In another embodiment, the second positioning part 132 and the at least two first positioning parts 121R1 and 121R2 may be in a reversed configuration. For instance, the second positioning part 132 may be on the outer ring component 120, while the first positioning parts 121 R1 and 121R2 may be on the inner ring component 130. Specifically, the outer ring component 120 may include a protruding structure, and the inner ring component 130 may include a plurality of recessed structures. Alternatively, the outer ring component 120 may include a plurality of recessed structures, while the inner ring component 130 may include a protruding structure. Through the relative movement of the outer ring component 120 and the inner ring component 130 in the rotation axis S, the protruding structure engages with one of the plurality of recessed structures.

Please refer to FIG. 3, FIG. 4, and FIG. 5B, the outer ring component 120 further includes a protrusion 123, and the protrusion 123 protrudes from the inner circumferential surface 121S of the annular body 121. The inner ring component 130 includes a recess 134R, and the recess 134R is recessed into the outer surface of the sidewall part 134 and penetrates through the inner ring component 130 along the Z-axis direction, from the positive Z-axis side to the negative Z-axis side. Accordingly, the recess 134R has open ends on both the positive and negative Z-axis sides. While the outer ring component 120 and the inner ring component 130 are assembled, the protrusion 123 is within the recess 134R, and the shape of the protrusion 123 corresponds to that of the recess 134R. Since the recess 134R is formed along the Z-axis direction, the outer ring component 120 may move relative to the inner ring component 130 along the Z-axis direction through the protrusion 123 and the recess 134R. Moreover, while the outer ring component 120 rotates, the outer ring component 120 drives the inner ring component 130 to rotate synchronously through the protrusion 123 and the recess 134R.

Please refer to FIG. 1 and FIG. 2, the rotary dial structure 100 further comprises an elastic movable component 140, and the elastic movable component 140 is substantially parallel to the rotation axis S. While the inner ring component 130 is driven by the outer ring component 120 and rotates synchronously with the outer ring component 120 around the rotation axis S, the elastic movable component 140 provides tactile feedback with a detent feeling.

The elastic movable component 140 is between the base 110 and the inner ring component 130. In a specific embodiment, the supporting seat 111 of the base 110 may have a groove 111R. The elastic movable component 140 is on the supporting seat 111 through the groove 111R. The elastic movable component 140 may include an elastic element 141 and an embedding element 142. One end of the elastic element 141 is connected to the supporting seat 111, and another end of the elastic element 141 is connected to the embedding element 142. The elastic element 141 may be implemented as a compression spring.

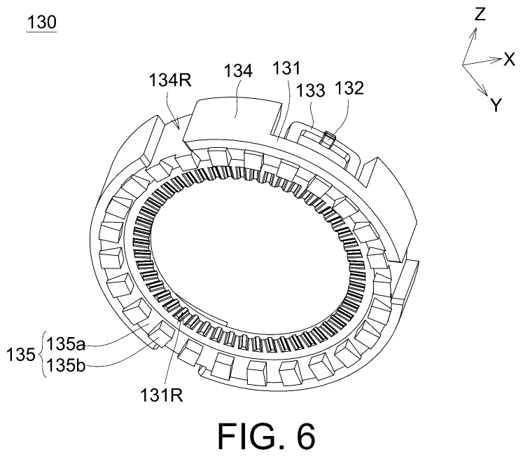

FIG. 6 is a 3D view of the inner ring component 130 of FIG. 3 from another viewpoint. Please refer to FIG. 2 and FIG. 6, the inner ring component 130 further includes a plurality of embedding grooves 131R. These embedding grooves 131R are along the rotational direction of the inner ring component 130 and are recessed into the base part 131 from its bottom surface in the positive Z-axis direction. The groove 111R of the supporting seat 111 corresponds to one of the embedding grooves 131R. While the elastic movable component 140 is inserted into the groove 111R of the supporting seat 111, the embedding element 142 protrudes from the supporting seat 111 and is against one of the embedding grooves 131R and the elastic element 141.

During the synchronous rotation of the outer ring component 120 and the inner ring component 130, the base part 131 of the inner ring component 130 generates a force that drives the embedding element 142 to move along the Z-axis, thereby compressing the elastic element 141. In the process where the outer ring component 120 and the inner ring component 130 continue to rotate, causing the embedding element 142 to gradually move away from the embedding groove 131R that it is originally against and to approach the next adjacent embedding groove 131R, the embedding element 142 is against the next adjacent embedding groove 131R by the restoring force of the elastic element 141. Thus, the embedding element 142 sequentially passes through these embedding grooves 131R, thereby providing tactile feedback in the form of a detent feeling.

Please refer to FIG. 1 and FIG. 2, the rotary dial structure 100 may further comprise a signal sensing module 150. While the outer ring component 120 is at the first position and rotates synchronously with the inner ring component 130, the signal sensing module 150 detects an operation signal of a first mode. While the outer ring component 120 is at the second position and rotates synchronously with the inner ring component 130, the signal sensing module 150 detects an operation signal of a second mode.

The signal sensing module 150 may include a switching module 150A and a light sensing module 150B. The switching module 150A is configured to detect whether the current mode of the rotary dial structure 100 is the first mode or the second mode. The switching module 150A may have a switch 151A and a circuit board 152A, and the switch 151A is on the circuit board 152A. While the outer ring component 120 is at the first position, the switch 151A is not triggered by the outer ring component 120 and outputs an activation signal for the first mode. Conversely, while the outer ring component 120 is at the second position, the outer ring component 120 triggers the switch 151A, and the switch 151A outputs an activation signal for the second mode.

The light sensing module 150B is configured to detect rotation signals of the inner ring component 130. The light sensing module 150B may include a light sensor 151B and a circuit board 152B, and the light sensor 151B is on the circuit board 152B. Please refer to FIG. 2 and FIG. 6, the inner ring component 130 may include a light-detectable stripe structure 135. The light-detectable stripe structure 135 is formed on the bottom surface of the base part 131 and is along the rotational direction of the inner ring component 130. While the inner ring component 130 is driven by the outer ring component 120 to rotate synchronously with the outer ring component 120, the light sensor 151B detects changes in the light-detectable stripe structure 135 and output a rotation signal. In a specific embodiment, the light-detectable stripe structure 135 may include alternating bright and dark sensing stripes 135a and 135b. The light sensor 151B may include a first light sensing unit 151B1 and a second light sensing unit 151B2. The first light sensing unit 151B1 and the second light sensing unit 151B2 respectively detect changes in the sensing stripes 135a and 135b and output corresponding rotation signals.

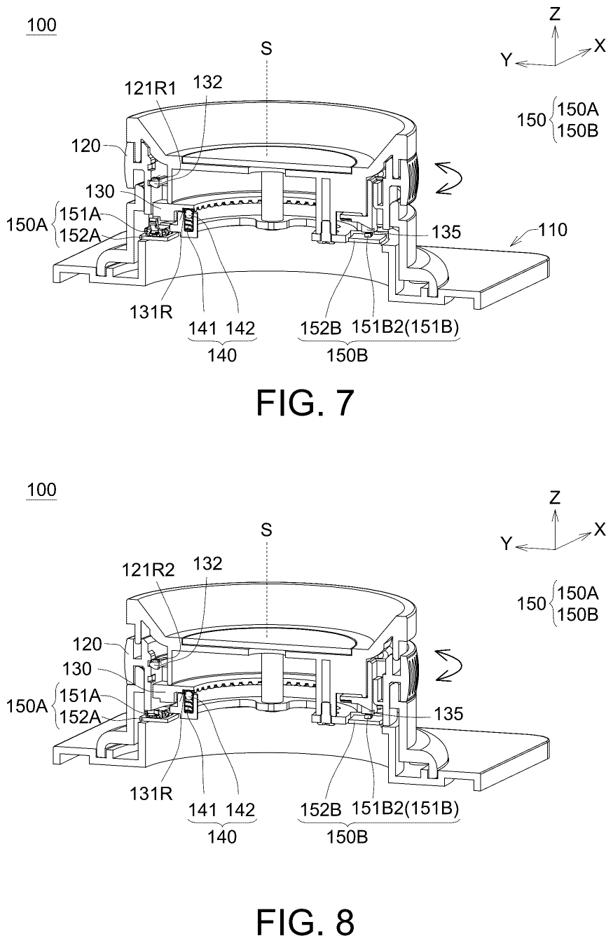

FIG. 7 is a 3D cross-sectional view of the rotary dial structure 100 of FIG. 1 along the section line 7-7′, illustrating the outer ring component 120 at the first position. FIG. 8 is a 3D cross-sectional view of the rotary dial structure 100, illustrating the outer ring component 120 at the second position.

Please refer to FIG. 7, the second positioning part 132 is in the first positioning part 121R1 to position the outer ring component 120 at the first position. At this point, the switch 151A is not triggered by the outer ring component 120, so the switch 151A outputs an activation signal for the first mode. While the outer ring component 120 and the inner ring component 130 rotate synchronously around the rotation axis S, the elastic movable component 140 provides tactile feedback with a detent feeling to the user. Furthermore, the light sensing module 150B detects changes in the light-detectable stripe structure 135, such as detecting the rotational direction of the inner ring component 130 as clockwise or counterclockwise, and/or detecting the rotational speed of the inner ring component 130, thus outputting corresponding rotation signals. As a result, while the outer ring component 120 is at the first position and rotates synchronously with the inner ring component 130, the signal sensing module 150 detects the operation signal of the first mode.

Please refer to FIG. 8, where the second positioning part 132 is in the first positioning part 121 R2 to position the outer ring component 120 at the second position. At this point, the outer ring component 120 is pressed down and triggers the switch 151A, and then the switch 151A outputs an activation signal for the second mode. As the outer ring component 120 and the inner ring component 130 rotate synchronously around the rotation axis S, the elastic movable component 140 provides tactile feedback with a detent feeling to the user. Furthermore, the light sensing module 150B detects changes in the light-detectable stripe structure 135, such as detecting the rotational direction of the inner ring component 130 as clockwise or counterclockwise, and/or detecting the rotational speed of the inner ring component 130, thus outputting the corresponding rotation signal. As a result, while the outer ring component 120 is at the second position and rotates synchronously with the inner ring component 130, the signal sensing module 150 detects the operation signal of the second mode.

In an embodiment, the rotary dial structure 100 may further comprise a control module (not shown). The control module is electrically connected to the signal sensing module 150 and switches between the first and second modes based on the activation signals output by the switching module 150A. Additionally, the control module adjusts the functions corresponding to the first and second modes based on the rotation signals output by the light-sensing module 150B. These adjustments may include changes to camera settings, such as aperture, focal length, depth of field, camera image style, and so on.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A rotary dial structure, comprising:
a base;
an inner ring component, being on the base; and
an outer ring component, sleeving onto the inner ring component, the outer ring component and the inner ring component are relatively movable between a first position and a second position, and the outer ring component and the inner ring component are synchronously rotatable at the first position or the second position.

2. The rotary dial structure according to claim 1, wherein the rotary dial structure further comprises a signal sensing module, while the outer ring component rotates synchronously with the inner ring component at the first position, the signal sensing module senses an operation signal of a first mode, and/or while the outer ring component rotates synchronously with the inner ring component at the second position, the signal sensing module senses an operation signal of a second mode.

3. The rotary dial structure according to claim 2, wherein the signal sensing module includes a switching module, and the switching module has a switch.

4. The rotary dial structure according to claim 2, wherein the signal sensing module includes a light sensor, and the inner ring component includes a light-detectable stripe structure.

5. The rotary dial structure according to claim 1, wherein the inner ring component includes two first positioning parts and the outer ring component includes a second positioning part, or the inner ring component includes a second positioning part and the outer ring component includes two first positioning parts, the outer ring component is at the first position or the second position by engaging the second positioning part with one of the first positioning parts.

6. The rotary dial structure according to claim 1, wherein the inner ring component further includes an elastic part and a protruding structure, and the protruding structure is on the elastic part.

7. The rotary dial structure according to claim 1, wherein the rotary dial structure further comprises an elastic movable component, and the elastic movable component is between the base and the inner ring component.

8. The rotary dial structure according to claim 7, wherein the elastic movable component includes an elastic element and an embedding element, the inner ring component has a plurality of embedding grooves along a rotational direction of the inner ring component, and the embedding element is against one of the embedding grooves and the elastic element.

9. The rotary dial structure according to claim 1, wherein the outer ring component and the inner ring component respectively include a protrusion and a recess, the outer ring component is movable relative to or synchronously rotatable with the inner ring component through the protrusion and the recess.

10. A rotary dial structure, comprising:
an inner ring component, including a light-detectable stripe structure,
an outer ring component, sleeving onto the inner ring component, the outer ring component and the inner ring component are relatively movable between a first position and a second position, and the outer ring component and the inner ring component are synchronously rotatable at the first position or the second position; and
a signal sensing module, including a switching module and a light sensor, the switching module outputs an activation signal of a first mode or a second mode based on that the outer ring component is at the first position or the second position; and while the outer ring component and the inner ring component rotate synchronously, the light sensor detects changes in the light-detectable stripe structure and outputs a rotation signal.

11. The rotary dial structure according to claim 10, wherein the switching module has a switch, while the outer ring component is at the first position, the switch outputs an activation signal for the first mode; and while the outer ring component is at the second position, the switch outputs an activation signal for the second mode.

12. The rotary dial structure according to claim 10, wherein the light-detectable stripe structure is along a rotational direction of the inner ring component.

13. The rotary dial structure according to claim 10, wherein the inner ring component includes two first positioning parts and the outer ring component includes a second positioning part, or the inner ring component includes a second positioning part and the outer ring component includes two first positioning parts, the outer ring component is at the first position or the second position by engaging the second positioning part with one of the first positioning parts.

14. The rotary dial structure according to claim 10, wherein the inner ring component further includes an elastic part and a protruding structure, and the protruding structure is on the elastic part.

15. A rotary dial structure, comprising:
a base;
an inner ring component, being on the base;
an outer ring component, sleeving onto the inner ring component, the outer ring component and the inner ring component are relatively movable between a first position and a second position, and the outer ring component and the inner ring component are synchronously rotatable at the first position or the second position; and
a signal sensing module, detecting an operation signal of a first mode or an operation signal of a second mode based on that the outer ring component and the inner ring component rotate synchronously at the first position or the second position.

16. The rotary dial structure according to claim 15, wherein the signal sensing module includes a switching module, the switching module has a switch, while the outer ring component is at the first position, the switch outputs an activation signal for the first mode; and while the outer ring component is at the second position, the outer ring component triggers the switch and the switch outputs an activation signal for the second mode.

17. The rotary dial structure according to claim 15, wherein the signal sensing module includes a light sensor, the inner ring component includes a light-detectable stripe structure, while the outer ring component and the inner ring component rotate synchronously, the light sensor detects changes in the light-detectable stripe structure and outputs a rotation signal.

18. The rotary dial structure according to claim 15, wherein the inner ring component further includes an elastic part and a protruding structure, and the protruding structure is on the elastic part.

19. The rotary dial structure according to claim 15, wherein the rotary dial structure further comprises an elastic movable component, and the elastic movable component is between the base and the inner ring component.

20. The rotary dial structure according to claim 19, wherein the elastic movable component includes an elastic element and an embedding element, the inner ring component has a plurality of embedding grooves along a rotational direction of the inner ring component, and the embedding element is against one of the embedding grooves and the elastic element.
